(19) United States
(12) Patent Application Publication
(10) Pub. No.: US 2023/0177841 A1
(43) Pub. Date: Jun. 8, 2023

(54) AUTOMATIC OBJECT DETECTION FOR UNDERWATER CAMERAS

(71) Applicant: X Development LLC, Mountain View, CA (US)

(72) Inventors: Kathy Sun, Boulder Creek, CA (US); Peter Kimball, Mountain View, CA (US); Harrison Pham, Sunnyvale, CA (US); Ryan Heacock, Cupertino, CA (US); Andrew Rossignol, Mountain View, CA (US); Mirkó Visontai, Mountain View, CA (US)

(21) Appl. No.: 17/643,308

(22) Filed: Dec. 8, 2021

(51) Int. Cl. G06V 20/56; G06V 10/44; G06V 20/05; G06V 10/56; G03B 17/08; B63G 8/00; G06N 20/10

(52) U.S. Cl. CPC G06V 20/56; B63G 8/001; G03B 17/08; G06N 20/10; G06V 10/44; G06V 10/56; G06V 20/05; B63G 2008/004

(57) ABSTRACT

Methods, systems, and apparatus, including computer programs encoded on computer-storage media, for automatic object detection for underwater cameras. In some implementations, an underwater camera captures many images which are obtained by a control unit. The control unit can detect one or more contours within a captured image based on values representing pixels of the image, generate a representation of the image based on the detected contours, provide the representation to a model that is trained to classify an input image as including a net or as not including a net, and perform an action based on classifying the image as including a net.

### FIELD

This specification generally relates to camera controllers, particularly those that are used for underwater cameras.

### BACKGROUND

Underwater camera systems may be equipped with propulsion units, including motors with propellers, and may be connected to ropes or winches that control the position of the camera system. Underwater camera systems may operate in underwater enclosures, such as nets or pens that are made out of rope, metal, or synthetic materials. If an underwater camera system strikes an underwater enclosure, the underwater enclosure may be damaged, e.g., by breaking a rope and creating a hole in the enclosure. Such damage may result in the escape of fish, which may have undesirable consequences on a nearby population of other fish, as well as the surrounding ecosystem as a whole.

Prevention of such strikes may involve manual observation of the camera, however, manual observation is time-consuming, and may only be possible when the underwater camera system is near the surface of water and is visible. Even when the underwater camera system is visible, however, human involvement in the observation process makes it expensive and reliant on the availability of human observers, which can be a challenge outside of normal business hours or in inclement weather.

### SUMMARY

In general, innovative aspects of the subject matter described in this specification relate to the prevention of strikes between underwater cameras and nets, by imaging portions of an enclosure and processing a representation of the images to determine if the images include a representation of a net. The images are obtained by a submersible device equipped with cameras. The submersible device may be communicably connected to a control unit that processes the images. The control unit preprocesses the images to determine contour shapes and then provides data indicating the contour shapes to a trained model to classify whether or not the images include depictions of nets. If a net is visible, the control unit can generate a movement command to halt the movement of the device, deactivate a portion of the device that may slice through a net, or move the device away from the net.

By determining whether or not an image includes a net based on a preprocessed representation of the image (e.g., a histogram of all contour areas detected in the image or a binary image indicating contours), the trained model may be more efficient and require less computing power than processing the initial captured image. Efficiency improvements may allow the net detection processing to be performed continuously in order to prevent damage to a net or enclosure. By generating a movement command or notifying users of a device’s proximity to a net, a system for net detection as described herein may prevent net damage and subsequent damage to the wider ecosystem through fish escapes as well as loss of fish stock.

One innovative aspect of the subject matter described in this specification is embodied in a method that includes: obtaining an image captured by an underwater camera; detecting one or more contours within the image based on values representing pixels of the image; generating a representation of the image based on the detected contours; providing the representation to a model that is trained to classify an input image as including a net or as not including a net; and performing an action based on the model classifying the image as including a net.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the action includes generating a movement command. In some implementations, the movement command is configured to move the underwater camera away from the net. In some implementations, the actions include training the model, where the training includes providing, to the model, representations of images that include visual representations of nets; and adjusting weights of the model based on output of the model processing the representations of the images compared to a label corresponding to the representations of the images.

In some implementations, the model is a support vector machine (SVM). In some implementations, the representation of the image based on the detected contours includes a histogram including each detected contour assigned to bins based on an area of each detected contour. In some implementations, the representation of the image based on the detected contours includes a binary image showing contours in a first color and contour boundaries in a second color.

In some implementations, the actions include obtaining a direction in which the underwater camera that captured the image is pointing; and determining the action to perform based on the direction of the underwater camera. In some implementations, obtaining the direction includes obtaining an identifier of the underwater camera; and determining the direction the underwater camera is pointing based on a known location of the underwater camera on a submersible device and the identifier of the underwater camera.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system that is used for automatic net detection and camera/net collision avoidance.

FIG. 2 is a flow diagram illustrating an example of a process for automatic net detection.

FIG. 3 is an example of representations of images after contour detection.

FIG. 4 is a diagram illustrating an example of a computing system used for automatic net detection.

Like reference numbers and designations in the various drawings indicate like elements.

### DETAILED DESCRIPTION

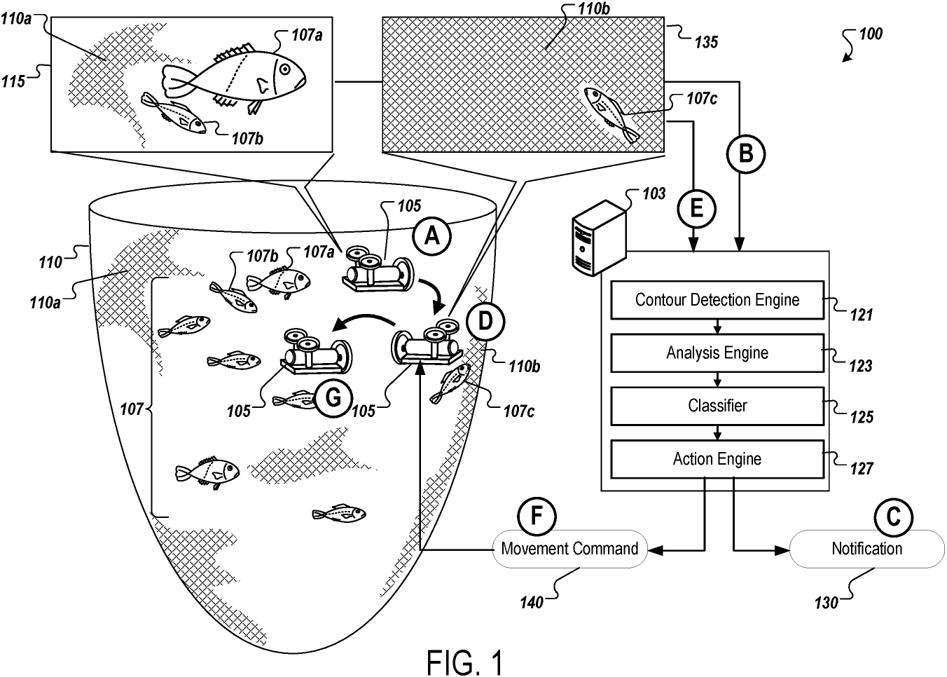

FIG. 1 is a diagram showing an example of a system 100 that is used for automatic net detection and camera/net collision avoidance. The system 100 includes a control unit 103 and a camera device 105. Generally speaking, the control unit 103 obtains images captured by cameras of the camera device 105 and processes the images to generate commands for controlling the camera device 105 as well as to generate notifications or instructions. In this example, the camera device 105 includes propellers to move the camera device 105 around the fish pen 110. In general, the camera device 105 may use any method of movement including ropes and winches, waterjets, thrusters, tethers, buoyancy control apparatus, chains, among others.

In some implementations, the camera device 105 is equipped with the control unit 103 as an onboard component, while in other implementations, the control unit 103 is not affixed to the camera device 105 and is external to the camera device 105. For example, the camera device 105 may provide images 115 and 135 over a network to the control unit 103. Similarly, the control unit 103 can provide return data, including movement commands to the camera device 105 over the network.

Stages A through G of FIG. 1, depict two exemplary images, image 115 and image 135, obtained by the camera device 105 and are processed by the control unit 103. The images 115 and 135 include representations of elements inside the fish pen 110, such as the fish 107, as well as surfaces of the fish pen 110 enclosure. In this example, the fish pen 110 is a net made out of a meshed material. The net may be made from any appropriate materials including rope, metal, or synthetic materials including plastic.

In stage A, the camera device 105 is at a first position and obtains the image 115 representing a portion 110a of the fish pen 110 and fish 107a and 107b. In general, the camera device 105 may operate under water and may generate many images. The camera device 105 obtains the image 115 using a forward looking camera. In general, the camera device 105 can be fitted with multiple cameras pointing in different directions. For example, the camera device 105 can include a downward facing camera, a side facing camera, a top facing camera, among others, to obtain images.

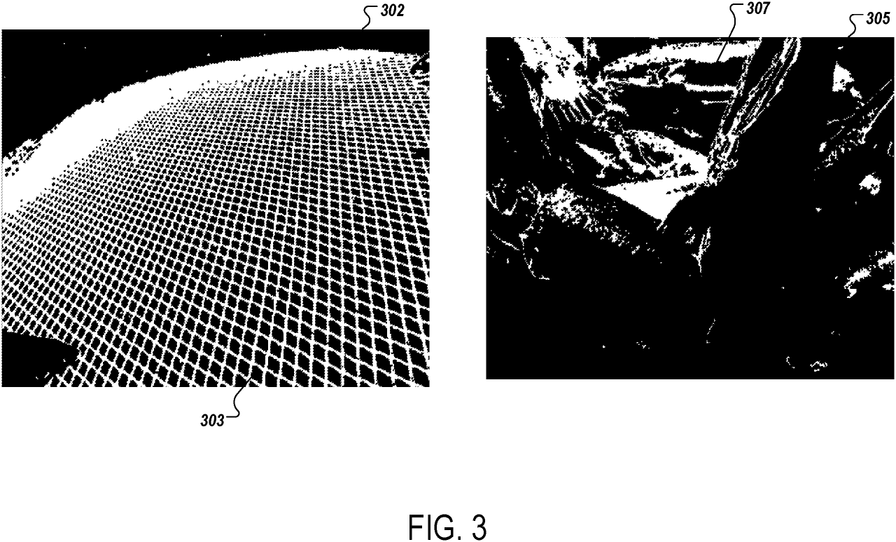

In stage B, the camera device 105 provides the image 115 to the control unit 103. The control unit 103 includes a contour detection engine 121, an analysis engine 123, a classifier 125, and an action engine 127. The contour detection engine 121 obtains the image 115 and processes the image to detect one or more contours. For example, the contour detection engine 121 can process groups of pixels based on values associated with each pixel and can determine, based on the values of the groups of pixels, whether or not a contour (e.g., contour 303 and 307 of FIG. 3) exists in the region corresponding to each processed group of pixels.

In some implementations, the contour detection engine 121 generates a binary representation of an input image. For example, the contour detection engine 121 can obtain the image 115 and determine the location of each contour bounding each shape. The contour detection engine 121 can output a binary representation (e.g., binary representations 302 and 305 of FIG. 3) of the image 115 where each contour representing the bounding lines of shapes are white and the shapes bounded are black. Flood filling may be used to fill an area identified by the contour detection engine 121 as a contour.

In some implementations, changes above a threshold are marked as edges of a contour. For example, the mesh of the fish pen 110 can be defined as a collection of contours with edges defined by the material used for the mesh. Various other shapes, including markings on fish and body parts such as fins and eyes, may also be defined as contours based on changes in values representing the various shapes.

The contour detection engine 121 can detect each hole of the portion 110a of the fish pen 110 as a contour based on pixel value changes from mesh material defining the hole. The contour detection engine 121 can also detect parts of fish 107a and 107b as contours such as tails, eyes, fins, gills, skin markings, among others.

The contour detection engine 121 determines an area for each detected contour. For example, for each hole of the portion 110a of the fish pen 110 as well as for each other shape within the image 115, the contour detection engine 121 can determine a corresponding area. In general, the areas corresponding to the contours of the holes in the fish pen 110 net are more uniform than the contours of other shapes detected based on the geometry of the mesh.

In some implementations, the contour detection engine 121 uses change thresholds to detect contours. For example, the contour detection engine 121 can determine pixel values corresponding to different areas and can detect where pixel value changes are above a threshold as a contour edge. By analyzing the image, the contour detection engine 121 can determine the locations of all contours defined as spaces enclosed by contour edges.

The analysis engine 123 obtains the contour detections of the contour detection engine 121. In some cases, the analysis engine 123 obtains contour areas from the contour detection engine 121. The analysis engine 123 can generate a representation of the obtained contour areas. For example, the analysis engine 123 can generate a histogram by assigning each contour area value to a bin.

In some implementations, the analysis engine 123 generates vectors for each bin. For example, the analysis engine 123 can generate a vector for recording contour areas within a certain area range, such as 5.0 in² to 5.2 in². For each contour area within the area range, the analysis engine 123 can add a representation of the contour area to a corresponding vector. In some cases, the vectors representing all bins can be combined into a matrix to improve computational efficiency in subsequent processing steps.

In some implementations, the analysis engine 123 obtains any of height, width, median area, and total number of contours from the contour detection engine 121. For example, the contour detection engine 121 can record a height and width for each contour detected. The contour detection engine 121 can also record the median area for all contours detected as well as the total number of contours detected. The analysis engine 123 can use the additional contour data to generate representations for classification by the classifier 125.

In some implementations, the analysis engine 123 determines a median area of a number of contours. For example, the analysis engine 123 can obtain areas of a number of contours and, based on the areas, generate a median area for the number of contours. The analysis engine 123 can generate a median area for multiple different sets of contours detected in an image. The analysis engine 123 can generate a correspondence between the median area of contours and a number of contours. The correspondence can be provided to the classifier 125.

The classifier 125 obtains the contour area representation generated by the analysis engine 123. The classifier 125 is trained using representations of images of nets. The representations of the images of nets can include contour area histograms specifying the number of contours corresponding to one or more ranges of area. In general, the histograms from known images of nets include a majority of contours with a same area while histograms from known images without nets include contours with multiple different areas.

In some implementations, the classifier 125 is a neural network. For example, the classifier 125 can include one or more layers with one or more adjustable weights that sequentially process an input representation of an image and determine, based on the weights in the one or more layers, whether the representation corresponds to a net. Ground truth data used for backpropagation and other training techniques to adjust the weights can include an indication of whether or not a training representation does, in fact, include a net representation.

In some implementations, the classifier 125 determines how far away a net is from a perspective of the device obtaining the image. For example, the classifier 125 can be trained using images of a specific net size and determine distance based on a training set with different known distances away from a net. In another example, the classifier 125 can obtain the actual size of the holes in the fish pen 110 and then determine a distance from a detected surface of the fish pen 110 based on comparing the apparent size of the holes in an obtained image, such as the image 115, to the known size of the holes.

In some implementations, the classifier 125 obtains contour data directly from the contour detection engine 121. For example, instead of the analysis engine 123 generating a histogram or determining a median contour area for groups of contours, the classifier 125 can obtain a representation of an image, such as the images 115 and 135, for classification. In some cases, the representation of the images 115 and 135 may resemble a binary image as shown in FIG. 3.

In some implementations, the classifier 125 includes a support vector machine (SVM). For example, the classifier 125 can obtain a representation of one or more detected contours and apply a trained SVM to determine, based on the representation, whether or not a net is visible. In some cases, the SVM can include a linear or third-degree polynomial kernal.

The action engine 127 obtains classification data from the classifier 125 and determines an action to perform. In the example of FIG. 1, the action engine 127 determines to generate a notification 130 configured to notify users of the system 100 that conditions are normal. In some cases, the notifications may include information that the camera device 105 is not near a surface of the fish pen 110.

In stage C, the notification 130 is provided by the control unit 103 to a network. The notification 130 is configured to be read by electronic devices of users of the system 100. The notification 130 may be configured to generate text or images on an electronic display of the devices. The text or images may include the image 115, a representation, such as a histogram or binary image, of one or more contours detected in the image 115, and images of similar images classified by the classifier 125, such as previously obtained images that either do, or do not, include net representations.

In stage D, after stage A, the camera device 105 moves to a location nearer to the net of the fish pen 110. The camera device 105 may be on patrol. The camera device 105 can continuously capture images and send the images to the control unit 103. The camera device 105 captures the image 135 that includes a portion 110b of the fish pen 110 and a fish 107c.

Similar to the processing of the image 115, the image 135 is processed by the contour detection engine 121, the analysis engine 123, the classifier 125, and the action engine 127 of the control unit 103. By detecting contours and analyzing the contours with the contour detection engine 121 and the analysis engine 123, the control unit 103 can be more efficient than a neural network trained to simply detect nets based appearance training data. Because the representations of the contours include fewer variables, the classifier 125 trained on representations of contours can be trained more efficiently and, after training, can perform more efficiently. This is important when running the net detection process continuously on obtained images to prevent accidental abrasions or damage to the net. A process that takes longer or requires more energy would need to be run less often potentially allowing devices to damage the net in the time between net detection processing.

After contour detection by the contour detection engine 121, the analysis engine 123 generates a representation of the detected contours. In some implementations, the analysis engine 123 generates a histogram of the areas of the contours detected by the contour detection engine 121. Compared to the histogram generated by the contours detected in the image 115, the histogram generated by the contours detected in the image 135 includes a greater percentage of contours in the same area bins. In other words, there may be less variance and more concentration of contours with area in the same area range when the image includes a representation of a net with relatively uniform geometry.

Similar to the classification of the representation corresponding to the image 115, the classification of the representation corresponding to the image 135 by the classifier 115 is performed by the classifier 125. The classifier 125 obtains the representation of the image 135. The representation of the image 135, generated by the analysis engine 123, may include a histogram of areas in any suitable format including a matrix or vector of values indicating contours and corresponding contour areas of the image 135.

As discussed in reference to the classification of the image 115, the classifier 125 determines, based on characteristics of the representation of the image 135, that the image 135 includes a representation of a net. In general, the classifier 125 may classify a representation as indicative of a net if there is a concentration of contour areas within a subset of contour area ranges, such as one or two contour area ranges. That is, if the analysis engine 123 generates a histogram of contour areas, the classifier 125 is trained to classify a histogram with more contour areas concentrated in fewer contour area bins as more likely including a net representation than a histogram with fewer contour areas dispersed across more contour area bins based on labeled contour area histograms training data.

In stage F, the action engine 127 generates a movement command 140 in response to the classifier 135 determining the image 135 likely includes a net representation. The movement command 140 is configured to control the movement of the camera device 105 away from the net of the fish pen 110. In some implementations, the camera device 105 provides a direction from which an image was obtained. For example, the camera device 105 can include the direction from which the image 135 was obtained. The action engine 127 can use the direction information to determine, based on a net detected in a direction relative to the camera device 105, which direction to move so the camera device 105 moves away from the net.

In the example of FIG. 1, the action engine 127 obtains data indicating that the image 135 was obtained from the forward facing camera of the camera device 105. Based on the classifier 125 classifying the forward facing image 135 as including a net, the action engine 127 can generate a movement command 140 configured to move the camera device 105 back away from the net. The movement command 140 can include rotation as well as acceleration and deceleration.

In stage G, the camera device 105 has obtained the movement command 140 from the control unit 103 and moved to a new location away from the net of the fish pen 110. In some implementation, a notification may be generated with the movement command 140 to alert a user of the system 100 that the camera device 105 is being moved to protect the net of the fish pen 110. The notification may also be helpful in alerting users to possible issues which caused the camera device 105 to become close to the net of the fish pen 110, such as weather, fish movement, location data tracked by the camera device 105, and operational status of components including movement controllers (e.g., propellers, jets, winches, among others).

In some implementations, determining an image 135 likely includes a net representation is sufficient to trigger generating a movement command. For example, during normal operation, the camera device 105 may be confined within a central area of the fish pen 110 where occlusions from fish and the opacity of the water prevents net detection even when the net exists around the camera device 105. It is only at close proximity that the net becomes visible through the water and in spite of fish occlusions. In this way, if a net is detected, subsequent determinations of distance to the net may not be necessary as the detection itself implies close proximity. In this way, distance calculation need not be performed further increasing the efficiency of the net detection.

In some implementations, the movement command 140 is configured to move the camera device 105 to a predetermined safe location. For example, a user 100 of the system 100 can provide safe locations to the control unit 103. The control unit 103, after determining proximity to a net based on the classifier 125, can generate a movement command 140 to move the camera device 105 to the safe location (e.g., a center of the pen, docking station, out of the fish pen for servicing or inspection, among others).

In some implementations, the movement command 140 is configured to stop the camera device 105. For example, if the camera device 105 is moving when a net is detected, the movement command 140 can include operations for the camera device 105 to stop moving thereby reducing potential damage to the fish pen 110. The movement command 140 may include a series of instructions to be performed by the camera device 105 including stopping and then proceeding in a specific direction at a specific speed.

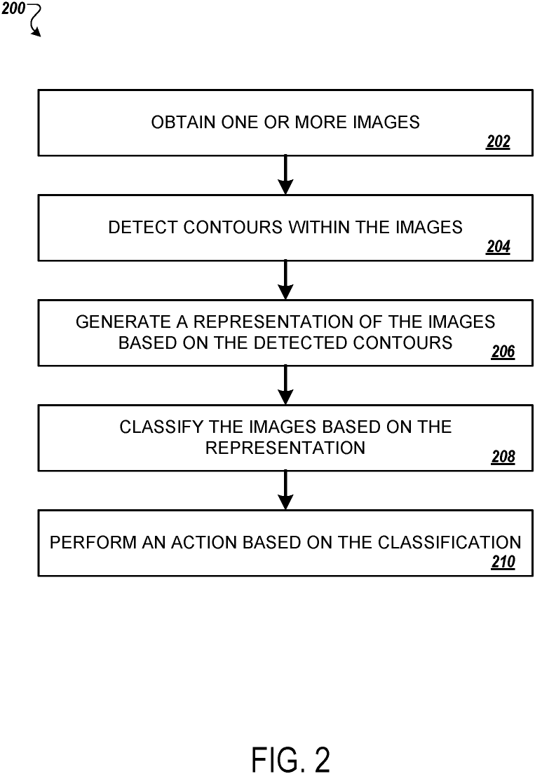

FIG. 2 is a flowchart illustrating an example of a process 200 for automatic net detection. The process 200 may be performed by one or more electronic systems, for example, the system 100 of FIG. 1.

The process 200 includes obtaining one or more images (202). For example, the control unit 103 can obtain the images captured by the camera device 105, such as the images 115 and 135. The images may be captured using any camera fixed on the camera device 105. The images obtained may include information indicating which camera of the camera device 105 was used to obtain the given image. The information, along with the images, can be provided by the camera device 105 to the control unit 103 for processing.

The process 200 includes detecting contours within the images (204). For example, the contour detection engine 121 of the control unit 103 can detect contours within the obtained images 115 and 135 by processing one or more values associated with pixels representing the images 115 and 135. In some implementations, changes of pixel values above a threshold are marked as contour edges and areas surrounded by contour edges are marked as contours.

The process 200 includes generating a representation of the images based on the detected contours (206). For example, the analysis engine 123 obtains the contour data generated by the contour detection engine 121 and generates a representation of the contour data. In some implementations, the analysis engine 123 generates a histogram indicating the areas of each contour detected by the contour detection engine 121. Each area is combined in bins of contour area ranges. The histogram may be generated in any suitable format including vectors, bytecode, matrices, among others.

The process 200 includes classifying the images based on the representation (208). For example, the classifier 125 can use an efficient neural network trained to determine whether a net is in an image based on the representation generated by the analysis engine 123. In some implementations, the classifier 125 is trained using labeled histogram data. The classifier 125 obtains histogram data representing contour areas of images that are known to include a net detection and images that are known to not include net detections. The classifier 125 generates the mapping of histogram input to a classification of net detection or no net detection to classify new, unlabeled input data as including a net or not including a net.

The process 200 includes performing an action based on the classification (210). For example, the action engine 127 determines, based on the classification of the classifier 125, what action to perform. After processing the image 115, the action engine 127 of the control unit 103 determines, based on no net detection, determines to generate and send the notification 130 configured to be received and displayed on electronic devices of users of the system 100 and to indicate the conditions of the camera device 105. In some implementations, the action engine 127 does not send notifications for normal conditions and instead performs actions only when conditions are not determined to be normal.

After processing the image 135, the action engine 127 generates the movement command 140. The movement command 140 is generated based on the classification of the classifier 125 and information of the image 135. For example, the action engine 127 determines, based on a direction and camera that obtained the image 135, that the net detected is in front of the camera device 105. To move away from the net and prevent damage, the camera device should move in the direction opposite the direction towards the net. The action engine 127 can use the information of the obtained image 135 to generate the movement command 140 specifying what direction and what distance the camera device 105 should move.

In some implementations, the action engine 127 additionally provides a notification to users of the system 100 indicating that the camera device 105 was in close proximity to the net of the fish pen 110. The notification may include the portion of the net where the camera device 105 was closest indicating that automatic or manual repair or inspection of the portion of the net should be performed to determine whether or not the camera device 105 caused any damage.

In some implementations, the action engine 127 generates the movement command 140 to move the camera device 105 to a servicing location. For example, if devices are serviced on a dock or pier nearby, the action engine 127 can generate the movement command 140 to move the camera device 105 to the service location so that the camera device 105 can be serviced or inspected for damage or malfunctioning components.

FIG. 3 is an example of representations of images after contour detection. The representations 302 and 305 are binary representations. The representation 302 includes a net. The representation 305 does not include a net. The black portions are contours surrounded by white contour edges. For example, contour 303 in representation 302 is a contour detected based on the hole in the mesh of a fish net. Contour 307 in representation 305 is a contour detected based on the overlapping appearance of fish in a fish pen.

Both representations 302 and 305 can be generated by the contour detection engine 121. The contour detection engine 121 generates representations based on input images captured from an underwater camera. The images captured from the underwater camera, such as the camera device 105, can be represented by red green blue (RGB), greyscale, or other formats. The contour detection engine 121 obtains those images and generates a simplified representation indicating all contours. Simplified representations can include binary representations as shown in FIG. 3.

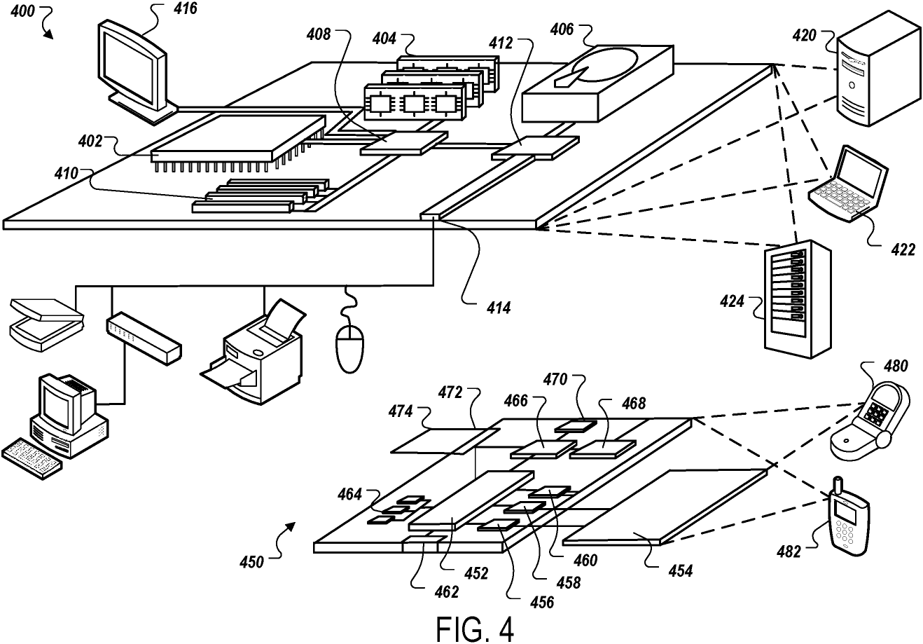

FIG. 4 is a diagram illustrating an example of a computing system used for automatic net detection. The computing system includes computing device 400 and a mobile computing device 450 that can be used to implement the techniques described herein. For example, one or more components of the system 100 could be an example of the computing device 400 or the mobile computing device 450, such as a computer system implementing the control unit 103, devices that access information from the control unit 103, or a server that accesses or stores information regarding the operations performed by the control unit 103.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402).The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method comprising:
obtaining an image captured by an underwater camera;
detecting one or more contours within the image based on values representing pixels of the image;
generating a representation of the image based on the detected contours;
providing the representation to a model that is trained to classify an input image as including a net or as not including a net; and
performing an action based on the model classifying the image as including a net.

2. The method of claim 1, wherein the action comprises:
generating a movement command.

3. The method of claim 2, wherein the movement command is configured to move the underwater camera away from the net.

4. The method of claim 1, comprising training the model, wherein the training comprises:
providing, to the model, representations of images that include visual representations of nets; and
adjusting weights of the model based on output of the model processing the representations of the images compared to a label corresponding to the representations of the images.

5. The method of claim 1, wherein the model is a support vector machine (SVM).

6. The method of claim 1, wherein the representation of the image based on the detected contours comprises:
a histogram including each detected contour assigned to bins based on an area of each detected contour.

7. The method of claim 1, wherein the representation of the image based on the detected contours comprises:
a binary image showing contours in a first color and contour boundaries in a second color.

8. The method of claim 1, comprising:
obtaining a direction in which the underwater camera that captured the image is pointing; and
determining the action to perform based on the direction of the underwater camera.

9. The method of claim 8, wherein obtaining the direction comprises:
obtaining an identifier of the underwater camera; and
determining the direction the underwater camera is pointing based on a known location of the underwater camera on a submersible device and the identifier of the underwater camera.

10. A non-transitory, computer-readable medium storing one or more instructions executable by a computer system to perform operations comprising:
obtaining an image captured by an underwater camera;
detecting one or more contours within the image based on values representing pixels of the image;
generating a representation of the image based on the detected contours;
providing the representation to a model that is trained to classify an input image as including a net or as not including a net; and
performing an action based on the model classifying the image as including a net.

11. The non-transitory, computer-readable medium of claim 10, wherein the action comprises:
generating a movement command.

12. The non-transitory, computer-readable medium of claim 11, wherein the movement command is configured to move the underwater camera away from the net.

13. The non-transitory, computer-readable medium of claim 10, comprising training the model, wherein the training comprises:
providing, to the model, representations of images that include visual representations of nets; and
adjusting weights of the model based on output of the model processing the representations of the images compared to a label corresponding to the representations of the images.

14. The non-transitory, computer-readable medium of claim 10, wherein the model is a support vector machine (SVM).

15. The non-transitory, computer-readable medium of claim 10, wherein the representation of the image based on the detected contours comprises:
a histogram including each detected contour assigned to bins based on an area of each detected contour.

16. The non-transitory, computer-readable medium of claim 10, wherein the representation of the image based on the detected contours comprises:
a binary image showing contours in a first color and contour boundaries in a second color.

17. The non-transitory, computer-readable medium of claim 10, comprising:
obtaining a direction in which the underwater camera that captured the image is pointing; and
determining the action to perform based on the direction of the underwater camera.

18. The non-transitory, computer-readable medium of claim 17, wherein obtaining the direction comprises:
obtaining an identifier of the underwater camera; and
determining the direction the underwater camera is pointing based on a known location of the underwater camera on a submersible device and the identifier of the underwater camera .

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining an image captured by an underwater camera;
detecting one or more contours within the image based on values representing pixels of the image;
generating a representation of the image based on the detected contours;
providing the representation to a model that is trained to classify an input image as including a net or as not including a net; and
performing an action based on the model classifying the image as including a net.

20. The system of claim 19, wherein the action comprises:
generating a movement command.
